(19) United States
(12) Patent Application Publication
(10) Pub. No.: US 2002/0143952 A1
(43) Pub. Date: Oct. 3, 2002

(54) Multimedia download timer system and method

(76) Inventors: Basuki Afandi Sugiarto, San Diego, CA (US); Masao Nishikawa, La Jolla, CA (US)

Correspondence Address: SKJERVEN MORRILL LLP, 25 METRO DRIVE, SUITE 700, SAN JOSE, CA, 95110, US

(21) Appl. No.: 09/822,685

(22) Filed: Mar. 30, 2001

(51) Int. Cl. G06F 15/173; G06F 15/16

(52) U.S. Cl. 709/227; 709/238

(57) ABSTRACT

A multimedia download timer system and method is provided. The multimedia download timer system allows users to purchase large content files from a source, such as an Internet content provider, and select various times to download the content files to the users' computers. For example, the large content files may comprise motion pictures, videos, audio files, such as music, or games. The various download times may be associated with various price options.

### BACKGROUND OF THE INVENTION

1. Field of the Invention

The present invention relates to data communications, and more particularly to downloading content from the Internet.

2. Description of the Related Art

User computers may download web pages and images from Internet content providers. Downloading large data files, such as images, may require a large portion of available Internet network bandwidth and/or require a long download time. When multiple download processes occur simultaneously, the network may not be able to sustain the demanded bandwidth. Thus, bandwidth will be reduced significantly, and communication processes may be delayed or disrupted.

### SUMMARY OF THE INVENTION

A multimedia download timer system and method is provided in accordance with the present invention. The multimedia download timer system allows users to purchase large content files from a source, such as an Internet content provider, and select various times to download the content files to the users' computers. For example, the large content files may comprise motion pictures, videos, audio files, such as music compilations, or games. The various download times may be associated with various price options.

One advantage of the timer system is network load balancing or load distribution. The timer system efficiently allocates network bandwidth usage by downloading large content files during periods of time when there will probably be reduced network traffic, e. g., 2 AM. Allocating bandwidth usage allows more network users to access network resources with less bottlenecks.

Another advantage of the timer system is giving users the option to select quicker service for a higher price or a delayed service for a discounted price. For example, the timer system allows a customer to select a time for downloading a content file at a time of the day when bandwidth usage and demand are most likely to be low, e.g., from 1 AM to 6 AM, and receive a discounted purchase price or coupon.

As a further example, there may be a large demand for a particular content file, such as a motion picture or music compilation, when it first becomes available for purchase by consumers. Bandwidth and communication resources may be unable to satisfy the large number of sudden customer orders for downloading the content file. The timer system may charge a premium price to customers who want to download the content file immediately. After a period of time, the demand may decrease, and the timer system may charge a lower price to customers who want to download the content file at a delayed time.

Another advantage of the timer system is its relatively low cost and relatively easy implementation.

One aspect of the invention relates to a system for downloading at least one multimedia content file to a plurality of user computers via a communication network. The system comprises a processor coupled to the communication network. The processor is configured to process a plurality of purchase requests from a plurality of user computers from the network. Each purchase request comprises a request to download at least one multimedia content file to a user computer at a user-selected time with a user-selected price. The system further comprises a storage device coupled to the processor. The storage device is configured to store at least one multimedia content file. The system further comprises at least one timer coupled to the processor. The processor is configured to use the timer to download at least one multimedia content file to a user computer at a user-selected time in response to a purchase request from the user computer.

Another aspect of the invention relates to a system for downloading at least one multimedia content file to a plurality of user computers via a communication network. The system comprises a processor, a storage device and at least one timer. The processor is coupled to the communication network. The processor is configured to process a plurality of purchase requests from a plurality of user computers from the network. Each purchase request comprises a request to download at least one multimedia content file to a user computer at a user-selected time. The storage device is coupled to the processor. The storage device is configured to store at least one multimedia content file. The timer is coupled to the processor. The processor is configured to use the timer to download at least one multimedia content file to a user computer at a user-selected time in response to a purchase request from the user computer.

Another aspect of the invention relates to a method of downloading at least one multimedia content file to a plurality of user computers via a communication network. The method comprises receiving a purchase request from a user computer via the network. The purchase request comprises a request to download at least one multimedia content file stored in a storage device to the user computer at a user-selected time with a user-selected price. The method also comprises downloading the requested multimedia content file to the user computer at the user-selected time in response to the purchase request from the user computer.

### BRIEF DESCRIPTION OF THE DRAWINGS

FIG. 1 illustrates one embodiment of a system for downloading content from a content provider to a plurality of user computers via one or more networks.

FIG. 2 illustrates a method of operating the system of FIG. 1.

### DETAILED DESCRIPTION

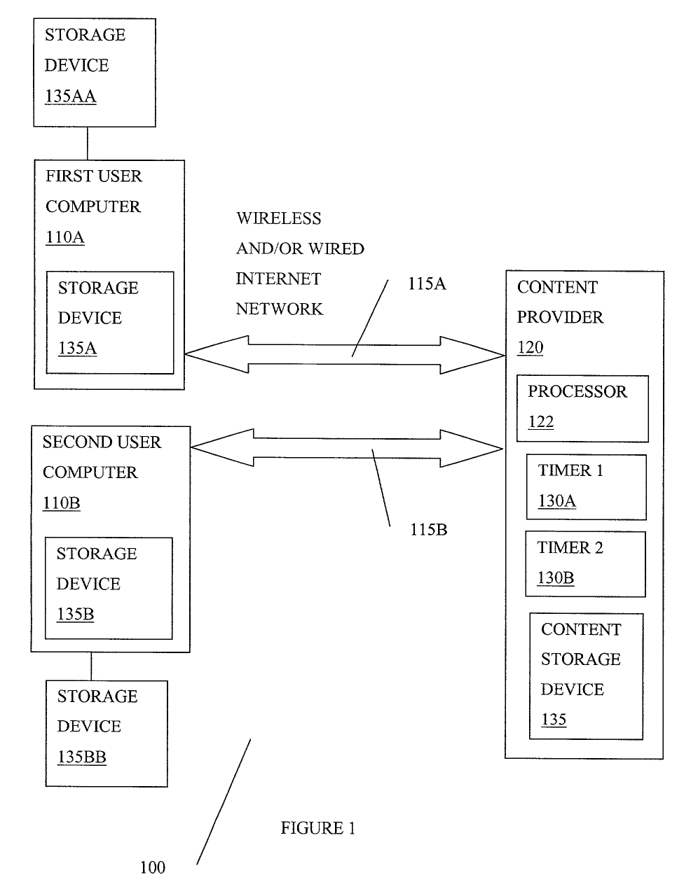

FIG. 1 illustrates one embodiment of a system 100 for downloading content from a content provider 120 to a plurality of user computers 110A, 110B (referred to herein individually or collectively as ‘computer 110’) via one or more communication network(s) 115A, 115B (referred to herein individually or collectively as ‘network 115’). Each content provider 120 comprises at least one processor 122, at least one content storage device 135 and one or more multimedia download timers 130A, 130B (referred to herein individually or collectively as ‘timer 130’). The system 100 may comprise any number of computers 110, networks 115 and content providers 120.

Each computer 120 in FIG. 1 may comprise a desktop, a laptop, a personal digital assistant (PDA), a palm-held, portable device or any device that can access the network(s) 115A-115B. The computers 110A and 110B in FIG. 1 comprise a storage device 135A and 135B, respectively, such as a hard drive, a disk array, a compact disc burner or a solid-state memory. The storage devices 135A and 135B are configured to store content files, such as motion pictures, audio files, e.g., music compilations, or games, e.g., video games, computer games, role-playing games, interactive games or multiple-player games. In an another embodiment, the computers 110A and 110B in FIG. 1 communicate with external storage devices 135AA and 135BB, respectively, such as a hard drive, a disk array, a compact disc burner or solid-state memory. Each computer 110 may comprise a wireless modem or be coupled to a wireless modem for communication with the content provider 120.

The network(s) 115A, 115B in FIG. 1 may comprise wired, wireless or a combination of wired and wireless communication systems. For example, the network(s) 115A, 115B may comprise a wireless communication system between the computers 110A-110B and a base station and a wired communication system between the base station and the content provider 120. A wireless communication system may comprise base stations, radio frequency transceivers, infrared transceivers, routers, central offices (COs) and/or mobile switching offices (MSOs). A wired communication system may comprise fiber optic cable, twisted wire pairs, switches, routers and/or central offices (COs). The network(s) 115A, 115B may use either narrowband or broadband communication systems. The network(s) 115A, 115B may use one or more communication protocols, such as the Open Systems Interconnection (OS) seven-layer model.

The content storage device 135 in FIG. 1 may be on-site at the content provider's facility or off-site at another location. The content storage device 135 may comprise one or more hard drives, disk arrays, servers, solid state memory or any other large capacity memory device. The content storage device 135 may comprise a plurality of smaller storage devices at one location or at different locations.

The content storage device 135 in FIG. 1 is configured to store large content files, such as motion pictures, videos, audio files, such as music, or games. The content files may be stored digitally and in coded or compressed formats. For example, a motion picture may be stored in a digital file comprising several megabytes to several hundred megabytes, e.g., 700 Mbytes. The content storage device 135 also stores pricing information appended to each content file.

The pricing information may comprise a plurality of different price options for downloading a content file at a plurality of different times. For example, a first discounted price, such as 5% less than a full purchase price, may be available for a content file to be downloaded to a user computer 110 during a first time period, such as 10:00 PM -12:00 AM. A second discounted price, such as 10% off, may be available for a content file to be downloaded to a user computer 110 at a second time, such as 12:00 AM-2:00 AM. A third discounted price, such as 15% off, may be available for a content file to be downloaded to a user computer 110 at a third time, such as 2:00 AM-4:00 AM.

In one embodiment, the content provider processor 122 coordinates the download times between time zones, such as Eastern Standard Time (EST) and Pacific Standard Time (PST) in the United States, to efficiently use bandwidth on the networks 115A-115B. In another embodiment, the content provider 120 has a plurality of content storage devices 135, and each content storage device 135 is configured to download content to computers 110 in a different time zone or geographic region.

In one embodiment, the content provider processor 122 staggers the scheduled content downloading times to efficiently allocate bandwidth of the network(s) 115A-115B. For example, the content provider processor 122 schedules a first download to the first computer 110A at 2:00 AM and a second download to the second computer 110B at 2:05 AM.

In one embodiment, the content provider processor 122 automatically monitors the level of bandwidth usage of the networks 115A and 115 during the day and adjusts the scheduled download times to efficiently allocate bandwidth of the networks 115A-115B. For example, the content provider processor 122 adjusts a scheduled download time to a time when bandwidth usage of the networks 115A and 115B is below a pre-determined level, such as 80%, 75%, 60% or 50% of maximum bandwidth capacity.

The multimedia download timers 130A-130B in FIG. 1 may be on-site at the content provider's facility or off-site at another location. The timers 130A-130B may be implemented with software, hardware or a combination of software and hardware. In one embodiment, the timers 130A-130B are integrated with the processor 122. Each timer 130 may comprise a counter, an internal clock, an external clock, such as a clock available from an Internet Service Provider (ISP) or a Global Positioning Satellite (GPS) timing receiver, which receives timing signals from a satellite. In one embodiment, each ‘timer 130’ simply represents a pre-determined time in the future, such as 2:00 AM, 2:05 AM or 2:10 AM. In one embodiment, there is only one timer 130 used by the processor 122. Each timer 130 may be configured by the content provider 120. Each timer 130 is configured to schedule a time to download large content files from the content provider. The term ‘time’ as used herein may refer to a specific time, such as 2:05 AM, or a period of time, such as 2:05 AM to 2:10 AM.

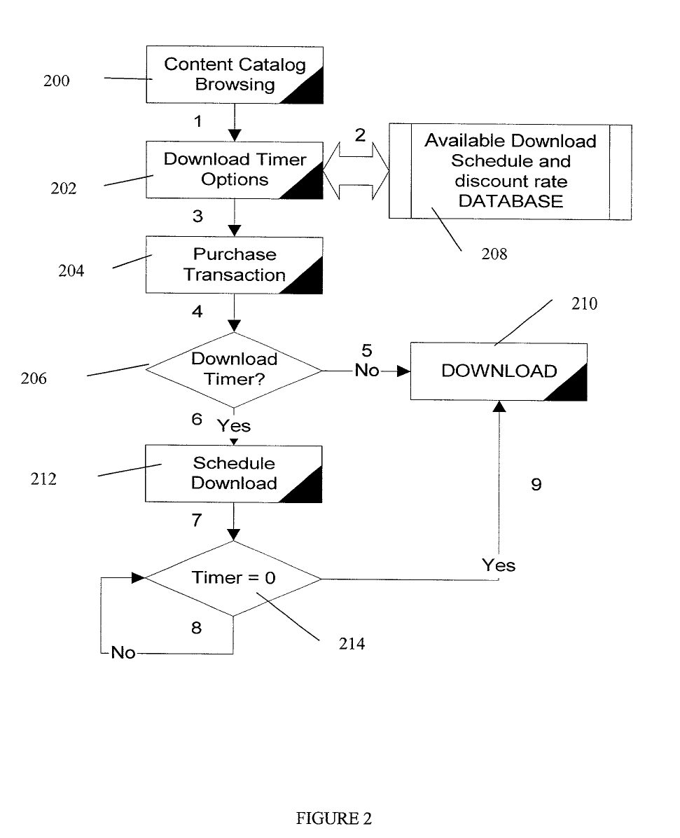

FIG. 2 illustrates a method of operating the system 100 of FIG. 1. In a start block 200 in FIG. 2, a user at the first computer 110A (FIG. 1) attempts to access an electronic catalog (i.e., a database or directory) of content files (e.g., movies or music) that are available for purchase from the content provider 120. In a process block 202, the content provider processor 122 may first determine whether the user is authorized to purchase content, i.e., determine whether the user has set up an account or entered a correct password. If the user is not authorized, the content provider processor 122 may prompt the user to open an account or prevent the user from proceeding.

In process blocks 202 and 208, the content provider processor 122 retrieves a list of content files and appended pricing information from the content storage device 135 and downloads the list of content files and pricing information to the user computer 110A.

In a process block 204, the user at the first computer 110A selects a content file for purchase and one of the available pricing options for downloading. In one embodiment, the user first agrees to make a purchase, then the content provider processor 122 provides a discount, rebate or refund to the user for downloading the selected content file at an off-peak time. Instead of a discounted price, the user may be offered a coupon of a pre-determined amount (e.g., 15% off) for future content purchases. In another embodiment, the content provider processor 122 first provides a discount, rebate or refund to the user for downloading the selected content file at a delayed time, then the user agrees to make a purchase and selects a download time. The user may also choose the method of payment, such as by credit card or automatic bank account withdrawal.

In a decision block 206, if the content provider processor 122 approves the transaction, the content provider processor 122 determines whether the user selected a delayed time, such as 2:00 AM, for the content file to be downloaded to the user computer 110A with a discounted price. If the user did not select delayed content downloading with a discounted price, then the content provider processor 122 begins to download the selected content file to the user computer 110A in a block 210. The content file may require a large amount of bandwidth on the network 115A and/or a long downloading time.

If the user's selected time for immediate downloading is during a period of the day when bandwidth usage and demand are most likely to be high, e.g., from 9 AM to 8 PM, then the user may be charged a premium price because bandwidth is at a premium. The Internet networks 115A- 115B are most likely to have high usage during work hours and evening hours. If the user's selected time for immediate downloading is during a period of the day of low bandwidth usage, e.g., from 1 AM to 7 AM, then the user may be charged a lower price because network bandwidth is not in high demand.

In a process block 212, the user selected a discounted price with delayed content downloading. In block 212, the content provider processor 122 ‘starts’ a timer, such as the first timer 130A. As described above, each ‘timer 130’ may be an actual timer or represent a pre-determined time in the future, such as 2:00 AM. If the timer 130A is an actual timer, then the content provider processor 122 sets the timer 130A to be the difference between the current time (e.g., 6 PM) and a time when bandwidth usage (traffic) will most likely be low (e.g., 2:00 AM). If the timer 130A represents a predetermined time in the future, such as 2:00 AM, then the content provider processor 122 sets the ‘timer 130A’ to expire at the pre-determined time.

In one embodiment, the content provider processor 122 prepares its software and hardware, such as the content storage device 135, and the user computer 110 to ensure that a communication channel sufficient for downloading the content file will be established at the agreed time. For example, the content provider processor 122 instructs the user computer 110 to determine whether the user computer 110 has sufficient memory to store the requested content file.

In a decision block 214, the content provider processor 122 determines whether the timer 130A has ‘expired.’ If the timer 130A has not ‘expired,’ then the content provider processor 122 waits until the timer 130A has expired. If the timer 130A has ‘expired,’ then the content provider processor 122 begins to download the selected content file to the user computer 110A in the block 210.

If the network connection is interrupted during the download process, then the content provider processor 122 may schedule another download time for downloading a part of the content file or the whole content file. If the user is at fault for an unsuccessful download, then the content provider processor 122 may remove the discount. If the user is not at fault for an unsuccessful download, then the content provider processor 122 may not remove the discount.

If the content file is successfully downloaded, the content file (e.g., movie, music or game) may be played by the user computer 110A. If the content file is successfully downloaded, the content provider processor 122 may prompt the user to download another content file.

In one embodiment, a user at a user computer 110 may negotiate a configurable price and a configurable download time with the content provider 120.

In one embodiment, the processor 122 sends offers to the user computers 110A-110B periodically or when a new content file becomes available for purchase.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A system for downloading at least one multimedia content file to a plurality of user computers via a communication network, the system comprising:
a processor coupled to the communication network, the processor being configured to process a plurality of purchase requests from a plurality of user computers from the network, each purchase request comprising a request to download at least one multimedia content file to a user computer at a user-selected time with a user-selected price;
a storage device coupled to the processor, the storage device being configured to store at least one multimedia content file; and
at least one timer coupled to the processor, wherein the processor is configured to use the timer to download at least one multimedia content file to a user computer at a user-selected time in response to a purchase request from the user computer.

2. The system of claim 1, wherein each content file is over 100 Megabytes in size.

3. The system of claim 1, wherein at least one multimedia content file comprises a motion picture.

4. The system of claim 1, wherein at least one multimedia content file comprises a music compilation.

5. The system of claim 1, wherein at least one multimedia content file comprises a game.

6. The system of claim 1, wherein the system is configured to provide access to a user computer of a list from the processor, the list comprising:
a plurality of titles of multimedia content files stored in the storage device; and
at least a first user-selectable time and a second user-selectable time for downloading a multimedia content file from the storage device to a user computer, the first user-selectable time corresponding to a time when network bandwidth usage is most likely high, the second user-selectable time corresponding to a time when network bandwidth usage is most likely low, the first user-selectable time being associated with a first user-selectable price, and the second user-selectable time being associated with a second user-selectable price, wherein the first user-selectable price is greater than the second user-selectable price.

7. The system of claim 6, wherein the first user-selected time is between about 8:00 AM and about 9:00 PM.

8. The system of claim 6, wherein the second user-selected time is between about 1:00 AM and about 7:00 AM.

9. The system of claim 1, wherein the processor is further configured to send offers periodically to a plurality of user computers, each offer comprising a title of at least one multimedia content file stored in the storage device and a plurality of user-selectable times for downloading the content file, each user-selected time being associated with a different price.

10. The system of claim 1, wherein the processor is further configured to send offers to a plurality of user computers, each offer comprising a title of at least one new multimedia content file stored in the storage device and a plurality of user-selectable times for downloading the content file, each user-selected time being associated with a different price.

11. The system of claim 1, wherein at least one user computer comprises a wireless modem configured to communicate wirelessly with a mobile switching office, the mobile switching office being configured to communicate with the processor.

12. The system of claim 1, wherein the communication network comprises at least one wireless communication portion.

13. The system of claim 1, wherein the processor is configured to monitor a level of bandwidth usage of the network and adjust a scheduled download time to a time when bandwidth usage is below a pre-determined level.

14. A system for downloading at least one multimedia content file to a plurality of user computers via a communication network, the system comprising:
a processor coupled to the communication network, the processor being configured to process a plurality of purchase requests from a plurality of user computers from the network, each purchase request comprising a request to download at least one multimedia content file to a user computer at a user-selected time;
a storage device coupled to the processor, the storage device being configured to store at least one multimedia content file; and
at least one timer coupled to the processor, wherein the processor is configured to use the timer to download at least one multimedia content file to a user computer at a user-selected time in response to a purchase request from the user computer.

15. The system of claim 14, wherein at least one multimedia content file comprises a motion picture.

16. The system of claim 14, wherein at least one multimedia content file comprises a music compilation.

17. The system of claim 14, wherein at least one multimedia content file comprises a game.

18. The system of claim 14, wherein each content file is over 100 Megabytes in size.

19. A method of downloading at least one multimedia content file to a plurality of user computers via a communication network, the method comprising:
receiving a purchase request from a user computer via the network, the purchase request comprising a request to download at least one multimedia content file stored in a storage device to the user computer at a user-selected time with a user-selected price; and
downloading the requested multimedia content file to the user computer at the user-selected time in response to the purchase request from the user computer.

20. The method of claim 19, further comprising charging the purchase price to a financial account associated with the user.

21. The method of claim 19, further comprising determining whether a user is authorized to purchase a content file.

22. The method of claim 19, further comprising providing a list to the user computer, the list comprising:
a plurality of titles of multimedia content files stored in the storage device; and
at least a first user-selectable time and a second user-selectable time for downloading a multimedia content file from the storage device to a user computer, the first user-selectable time corresponding to a time when network bandwidth usage is most likely high, the second user-selectable time corresponding to a time when network bandwidth usage is most likely low, the first user-selectable time being associated with a first user-selectable price, and the second user-selectable time being associated with a second user-selectable price, wherein the first user-selectable price is greater than the second user-selectable price.

23. A system for downloading at least one multimedia content file to a plurality of user computers via a communication network, the system comprising:
a processing means coupled to the communication network, the processing means being configured to process a plurality of purchase requests from a plurality of user computers from the network, each purchase request comprising a request to download at least one multimedia content file to a user computer at a user-selected time with a user-selected price;
a storing means coupled to the processing means, the storing means being configured to store at least one multimedia content file; and
at least one timing means coupled to the processing means, wherein the processing means is configured to use the timing means to download at least one multimedia content file to a user computer at a user-selected time in response to a purchase request from the user computer.

24. A method of downloading at least one multimedia content file to a plurality of user computers via a communication network, the method comprising:
receiving a purchase request from a user computer via the network, the purchase request comprising a request to download at least one multimedia content file stored in a storing means to the user computer at a user-selected time with a user-selected price; and
downloading the requested multimedia content file to the user computer at the user-selected time in response to the purchase request from the user computer.
